(19) United States
(12) Patent Application Publication
(10) Pub. No.: US 2019/0322050 A1
(43) Pub. Date: Oct. 24, 2019

(54) ADDITIVE MANUFACTURING SYSTEM AND METHOD

(71) Applicant: General Electric Company, Schenectady, NY (US)

(72) Inventor: Stuart David Connell, Clifton Park, NY (US)

(21) Appl. No.: 15/957,062

(22) Filed: Apr. 19, 2018

(51) Int. Cl. B29C 64/35; B29C 64/153; B29C 64/25; B33Y 10/00; B33Y 30/00; B22F 3/105; B28B 1/00

(52) U.S. Cl. CPC B29C 64/35; B29C 64/153; B29C 64/25; B22F 2003/1059; B33Y 30/00; B22F 3/1055; B28B 1/001; B33Y 10/00

(57) ABSTRACT

An additive manufacturing system includes a housing defining a chamber and a build platform disposed in a lower portion of the chamber. The additive manufacturing system includes a first gas inlet, disposed in a first side-wall of the chamber, configured to supply a first gas flow parallel to the build platform. The additive manufacturing system also includes a second gas inlet configured to supply a second gas flow in a direction substantially perpendicular to the build platform. The additive manufacturing system further includes a gas outlet configured to discharge the first and second gas flows from the chamber.

### BACKGROUND

The subject matter disclosed herein relates to an additive manufacturing system and method, and specifically, to an additive manufacturing system and method that employs focused energy to selectively fuse a powder material to produce an object.

Additive manufacturing (AM) processes generally involve the buildup of one or more materials to make a net or near-net shape object, in contrast to subtractive manufacturing methods. Though “additive manufacturing” is an industry standard term (ASTM F2792), it encompasses various manufacturing and prototyping techniques known under a variety of names, including freeform fabrication, 3D printing, rapid prototyping/tooling, etc. A particular type of AM process uses a focused energy source (e.g., an electron beam, a laser beam) to sinter or melt a powder material deposited on a build platform within a chamber, creating a solid three-dimensional object in which particles of the powder material are bonded together.

Laser sintering is a common industry term used to refer to producing three-dimensional (3D) objects by using a laser beam to sinter or melt a fine powder. In particular, laser sintering/melting techniques often entail projecting a laser beam onto a controlled amount of powder (e.g., a powder bed) on a substrate, so as to form a layer of fused particles or molten material thereon. When the laser beam interacts with the powder at a powder bed, smoke and/or a particulate matter (e.g., condensate, spatter) is produced within the chamber. The smoke and/or the particular matter may be detrimental to the quality of the resulting object. As an example, the smoke and/or the particular matter may suspend within the chamber or may deposit onto a laser window, and in either case, the smoke and/or the particular matter can interfere with the laser beam and reduce the energy or intensity of the laser beam. As another example, the smoke and/or the particular matter may deposit onto the powder bed and may end up in the resulting object.

In certain AM systems, a laminar gas flow is introduced in the chamber to flow parallel to the build platform in an attempt to remove the smoke and/or particulate matter and prevent the deposition. However, the gas flow may entrain gas from the chamber resulting in a chaotic flow with large areas of recirculation within the chamber. This chaotic flow may trap or deposit the particulate matter in various parts of the chamber, which can lower the quality of the resulting object of the AM processes.

### BRIEF DESCRIPTION

In one embodiment, an additive manufacturing system includes a housing defining a chamber and a build platform disposed in a lower portion of the chamber. The additive manufacturing system includes a first gas inlet, disposed in a first side-wall of the chamber, configured to supply a first gas flow parallel to the build platform. The additive manufacturing system also includes a second gas inlet configured to supply a second gas flow in a direction substantially perpendicular to the build platform. The additive manufacturing system further includes a gas outlet configured to discharge the first and second gas flows from the chamber.

In another embodiment, a method of operating an additive manufacturing system includes depositing a quantity of a power material on a build platform within a chamber. The method includes supplying a first gas flow into the chamber horizontally above the build platform and supplying a second gas flow into the chamber in a direction substantially perpendicular to the first gas flow. The method also includes applying a focused energy beam to at least a portion of the quantity of the powder material deposited on the build platform to form a solidified layer.

In another embodiment, an additive manufacturing system includes a housing defining a chamber, a build platform disposed in the chamber, and a powder application device arranged in the chamber and configured to dispose a bed of powder material onto the build platform. The additive manufacturing system includes an energy generating system configured to generate and direct a focused energy beam onto at least a portion of the bed of powder material. The additive manufacturing system includes a positioning system coupled to the build platform, the energy generating system, the powder application device, or a combination thereof, and configured to move the build platform, the energy generating system, the powder application device, or a combination thereof, relative to one another. The additive manufacturing system also includes a first gas inlet configured to supply a first gas flow horizontally above the build platform, a second gas inlet configured to supply a second gas flow in a direction substantially perpendicular to the first gas flow, and a gas outlet configured to discharge the first and second gas flows.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an additive manufacturing (AM) system having a manufacturing chamber, in accordance with present embodiments;

FIG. 2 is a schematic three-dimensional view illustrating an embodiment of the manufacturing chamber of the AM system of FIG. 1 having both a top gas flow arrangement and a side gas flow arrangement, in accordance with present embodiments;

FIG. 3 is a schematic three-dimensional view illustrating results of an example simulation of flow characteristics in the manufacturing chamber of the AM system of FIG. 2 having only the side gas flow arrangement, in accordance with present embodiments;

FIG. 4 is a schematic three-dimensional view illustrating results of an example simulation of flow characteristics in the manufacturing chamber of the AM system of FIG. 2 having both the side gas flow arrangement and the top gas flow arrangement, in accordance with present embodiments; and

FIG. 5 is a flow chart of an embodiment of a method for operating the AM system of FIG. 2, in accordance with present embodiments.

### DETAILED DESCRIPTION

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise. The terms “first”, “second”, and the like, as used herein do not denote any order, quantity, or importance, but rather are used to distinguish one element from another. The term “uniform gas flow”, as used herein, means that the flow velocity of a gas flow does not significantly vary across a path of the gas flow. As used herein, the term “additive manufacturing” techniques may include, but are not limited to, Direct Metal Laser Melting, Direct Metal Laser Sintering, Direct Metal Laser Deposition, Laser Engineered Net Shaping, Selective Laser Sintering, Selective Laser Melting, Electron Beam Melting, Selective Heat Sintering, Selective Photocure, Selective Deposition Lamination, Smooth Curvatures Printing, Multi-jet Fusion, Multi-jet Modeling, Ultrasonic Additive Manufacturing, Digital Light Processing, Fused Filament Fabrication, Fused Deposition Modeling, Stereolithography, Hybrid Systems or combinations thereof.

The present disclosure generally encompasses systems and methods for manufacturing objects using additive manufacturing. As discussed in detail below, some embodiments of the present disclosure present additive manufacturing (AM) systems and methods that employ a combination of laminar gas flow (e.g., a first gas flow) supplied horizontally, parallel to, a build platform and a vertical gas flow (e.g., a second gas flow) supplied perpendicular to the build platform from the top of a chamber of the AM system. The addition of the vertical gas flow may advantageously overcome the above noted shortcomings of an AM system having only the laminar gas flow by suppressing entrainment and recirculation of the smoke and/or the particulate matter inside the chamber of the AM system. As such, the deposition of the smoke and/or particulate matter on various locations inside the chamber may be substantially reduced or eliminated, and thus may lead to improved quality of the resulting object of the AM process.

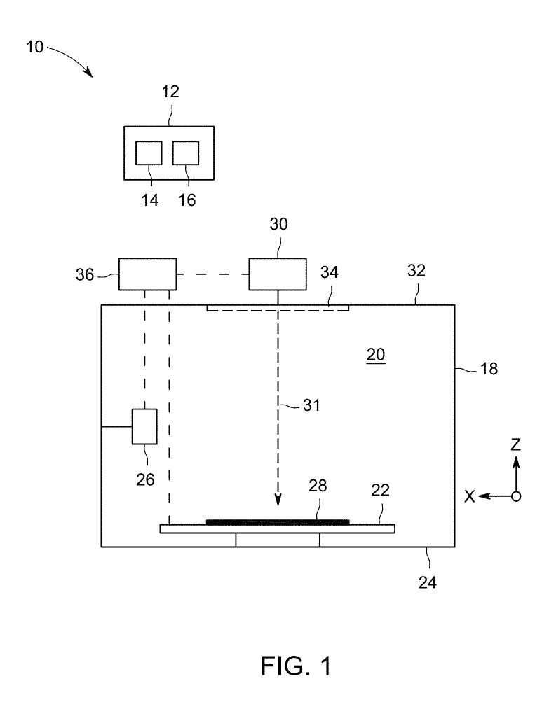

FIG. 1 illustrates an example embodiment of an AM system 10 for producing an article or object using a focused energy source or beam. In the illustrated embodiment, the AM system 10 includes a controller 12 having memory circuitry 14 that stores instructions (e.g., software, applications), as well as processing circuitry 16 configured to execute these instructions to control various components of the AM system 10. The AM system 10 includes a housing 18 defining a manufacturing chamber 20 (also referred to herein as chamber 20) having a volume. The chamber 20 is sealable to protect the build process from the ambient atmosphere. The AM system 10 includes a build platform 22 disposed inside the chamber 20 on a base portion or bottom-wall 24 of the housing 18. The article or object of the AM process is fabricated on the build platform 22.

The AM system 10 includes a powder application device 26, which may be arranged inside the chamber 20 to deposit a quantity of a powder material onto the build platform 22. The powder material deposited on the build platform 22 generally forms a powder bed 28. The build platform 22 may be movable in a vertical direction (e.g., in the z-direction) so that, with increasing construction height of the article while fabricating the article layer-by-layer, the build platform 22 may be moved downwards in the vertical direction. In other embodiments, other components (e.g., the powder application device 26) of the AM system 10 may be movable in the vertical direction with respect to the build platform 22 while the build platform 22 does not change height. The powder material may include, but is not limited to, polymers, plastics, metals, ceramics, sand, glass, waxes, fibers, biological matter, composites, or hybrids of these materials. These materials may be used in a variety of forms as appropriate for a given material and method, including for example without limitation, solids, powders, sheets, foils, tapes, filaments, pellets, wires, atomized, and combinations of these forms.

The AM system 10 includes an energy generating system 30 for generating and selectively directing a focused energy beam 31, such as laser, onto at least a portion of the powder bed 28 disposed on the build platform 22. For the embodiment illustrated in FIG. 1, the energy generating system 30 is arranged on a top portion or top-wall 32 of the housing 18, opposite to the base portion or the bottom-wall 24. The focused energy beam 31 enters the chamber 20 through a window 34. The powder bed 28 disposed on the build platform 22 is subjected to the focused energy beam 31 in a selective manner as controlled by the controller 12, depending on the desired geometry of the article. In some embodiments, the energy generating system 30 includes a focused energy source for generating the focused energy beam 31. In some embodiments, the focused energy source includes a laser source and the focused energy beam 31 is a laser beam, or includes an electron beam source and the focused energy beam 31 is an electron beam. In some embodiments, the laser source includes a pulsed laser source that generates pulsed laser beam. The pulsed laser beam is not emitted continuously, in contrast with a continuous laser radiation, but is emitted in a pulsed manner e.g., in time limited pulses with interval. In some embodiments, the energy generating system 30 includes a plurality of focused energy sources that is configured to selectively irradiate the focused energy beam 31 onto the powder bed 28. In embodiments where the focused energy includes a laser beam, the window 34 may be referred to as “laser window”.

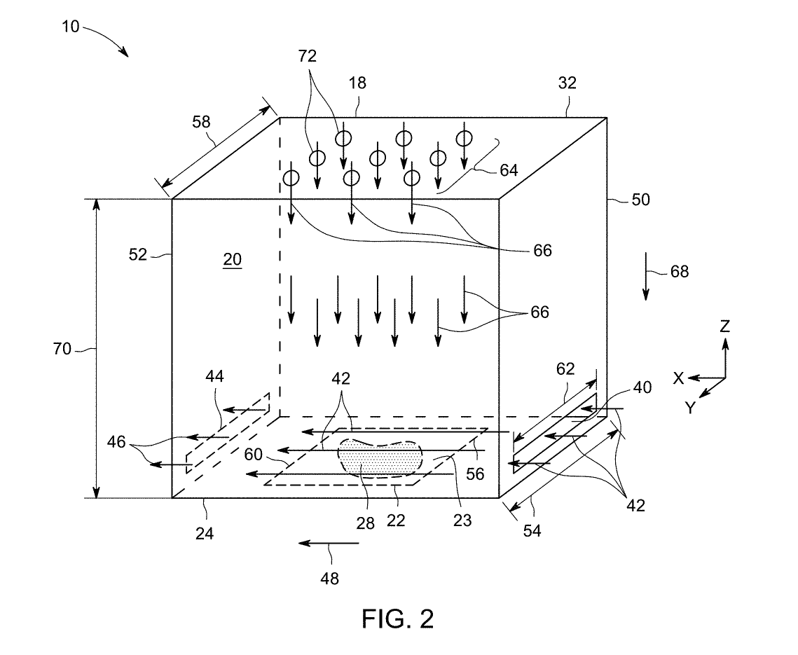

The AM system 10 includes a positioning system 36 (e.g., a gantry or other suitable positioning system). The positioning system 36 may be any multidimensional positioning system, such as a delta robot, cable robot, robot arm, or another suitable positioning system. The positioning system 36 may be operatively coupled to the powder application device 26, the energy generating system 30, the build platform 22, or a combination thereof. The positioning system 36 may move the powder application device 26, the energy generating system 30, the build platform 22, or a combination thereof, relatively to one another, in any of the x-, y-, and z-directions, or a combination thereof. The AM system 10 is further configured to supply a first gas flow and a second gas flow into the chamber 20 and discharge a gas flow from the chamber 20, as will be discussed in FIG. 2. The gas flow being discharged from the chamber 20 includes the first gas flow, the second gas flow, as well as a substantial portion of any smoke and/or particulate matter that is generated on application of the focused energy beam 31 to selectively melt or sinter the powder bed 28 during forming of desired article.

FIG. 2 is a schematic three-dimensional view illustrating an embodiment of the chamber 20 of the AM system 10, in accordance with present embodiments. As illustrated, the housing 18 includes a first gas inlet 40 for supplying a first gas flow (shown by arrows 42) to the chamber 20 and a gas outlet 44 for discharging a gas flow (as shown by arrows 46) from the chamber 20. The first gas inlet 40 and the gas outlet 44 are configured to allow the first gas flow 42 to flow substantially laminarly in a direction 48 (e.g., parallel to the x-direction, parallel to the surface of the build platform 22, perpendicular to the z-direction) horizontally above the build platform 22. In the illustrated embodiment, the first gas inlet 40 is arranged at a first side-wall 50 and the gas outlet 44 is arranged at a second side-wall 52 opposing the first side-wall 50 of the housing 18. Further, the first gas inlet 40 and the gas outlet 44 are arranged on the respective side-walls (50, 52) at locations (for example, towards the base portion 24) such that the first gas flow 42 travels substantially laminarly above an entire surface area of the build platform 22. As illustrated, the first gas inlet 40 extends along at least a substantial portion of a width 54 of the first side-wall 50 and parallelly aligns to a side 56 of the build platform 22. Similarly, the gas outlet 44 extends along at least a substantial portion of a width 58 of the second side-wall 52 and parallelly aligns to another side 60 of the build platform 22. In the illustrated embodiment, the values of the widths 54 and 58 are substantially the same. In other embodiments, the values of the widths 54 and 58 may be different from one another. Moreover, the first gas inlet 40 and the gas outlet 44 may be arranged towards the base portion 24 of the side-walls 50 and 52 (e.g., lower 25%, 10% of the first and second side-walls 50 and 52), such that the first gas flow 42 travels directly, tangentially above the build platform 22. In some embodiments, the first gas inlet 40 may be arranged at a greater vertical height (e.g., in the z-direction) than the build platform 22.

The first gas inlet 40 and gas outlet 44 are shown rectangular in shape in FIG. 2 for simplicity. However, the first gas inlet 40 and gas outlet 44 can be of any suitable (e.g., polygon, oval) that enables to provide the first gas flow 42 above substantially all of the area of the build platform 22. Further, the first gas inlet 40 may be coupled to a gas dispersal mechanism that is in turn, coupled to a gas supply line. The gas dispersal mechanism may help uniformly supply the first gas flow 42 through an entire length 62 of the first gas inlet 40. The gas outlet 44 may be coupled to a suction mechanism to draw and discharge the gas flow 46 from the chamber 20.

The AM system 10 as shown in FIG. 2, further includes a second gas inlet 64 for supplying a second gas flow to the chamber 20. The second gas inlet 64 is configured to supply the second gas flow (shown by arrows 66) in a substantially direction 68, substantially perpendicular relative to the first gas flow 42, perpendicular relative to the build platform 22. For example, the direction 68 of the second gas flow 66 is substantially parallel to the z-direction and is offset approximately 90° relative to the direction 48 of the first gas flow 42. The second gas inlet 64 may be arranged at the top portion or top-wall 32 of the chamber 20. The second gas inlet 64 may be arranged such that the second gas flow 66 is substantially uniformly distributed in the chamber 20 throughout a significant portion of a height 70 of the chamber 20. For example, the second gas inlet 64 is arranged such that the second gas flow 66 is substantially uniformly distributed along the direction 68, until the second gas flow 66 meets the first gas flow 62 above the build platform 22.

For the illustrated embodiment, the second gas inlet 64 includes a plurality of openings 72 in the top portion or top-wall 32 of the housing 18. The plurality of openings 72 may include an array of openings that allows the second gas flow 66 to flow substantially uniformly (i.e., substantially uniform second gas flow 66) along the direction 68. The plurality of openings 72 may be of any suitable shape and size that enable substantially uniform gas flow. In some embodiments, the plurality of openings 72 may be in form of circular holes. In some embodiments, the holes may have a diameter in a range from about 1 mm to about 10 mm. In some embodiments, the second gas inlet 64 may include only one opening having any suitable shape. The second gas flow 66 is generally discharged from the chamber 20 through the gas outlet 44. Further, the second gas inlet 64 may be coupled to a gas dispersal mechanism that is in turn, coupled to a gas supply line. The gas dispersal mechanism may help uniformly supply the second gas flow 66 through a significant portion of the height 70 of the chamber 20.

In some embodiments, the gas dispersal mechanism of the first gas flow 42 and the gas dispersal mechanism of the second gas flow 66 may be the same gas dispersal mechanism. In some embodiments, the gas dispersal mechanism of the first gas flow 42 and/or the gas dispersal mechanism of the second gas flow 66 may be coupled to the suction mechanism that removes the gas flow 46 from the chamber 20 to enable recirculation of the gas flows. In some embodiments, the suction mechanism may include a suitable filtration mechanism to filter or treat the discharged gas flow 46 and to recirculate the filtered gas flow 46 back to the chamber 20 through the first gas inlet 40 and/or the second gas inlet 64.

The first gas flow 42 and the second gas flow 66 include inert gas (e.g., argon, nitrogen, or the like, or a combination thereof). The first gas flow 42 and the second gas flow 66 may be supplied to the chamber 20 by one or more suitable conveying devices and/or flow regulating devices such as, one or more pumps or blowers, one or more fluid valves, or a combination thereof. In addition, the one or more suitable conveying devices and/or flow regulating devices may be operatively coupled to the controller 12, which is configured to control the first gas flow 42 and the second gas flow 66, in addition to the remainder of the AM system 10. The controller 12 may be configured to control one or more fluid flow characteristics, such as flow distribution, flow rate (e.g., mass flow rate, volume flow rate), flow direction, or any combination thereof.

Further, the first gas flow 42 and the second gas flow 66 are controlled by the controller 12 to substantially reduce or eliminate gas entrainment or chaotic gas flow within the chamber 20, such that the smoke and/or particulate matter (e.g., condensate, spatter) may be effectively removed from the chamber 20 (e.g., discharged from the chamber 20 via the gas outlet 44). In some embodiments, the flow rate of the second gas flow 66 may be in a range between about 1.5 times and about 2.5 times the flow rate of the first gas flow 42. In some embodiments, the flow rate of the second gas flow 66 may be in a range between about 1.8 times and about 2.2 times the flow rate of the first gas flow 42. In some embodiments, the flow rate of the second gas flow 66 may be in a range between about 1.9 times and about 2.1 times the flow rate of the first gas flow 42. In some embodiments, the flow rate (e.g., mass flow rate, volume flow rate) of the second gas flow 66 may be about 2 times the flow rate of the first gas flow 42.

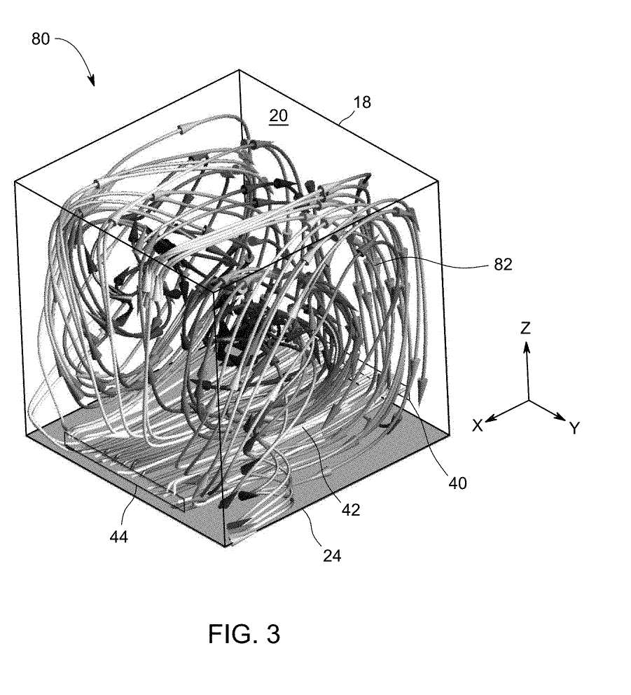

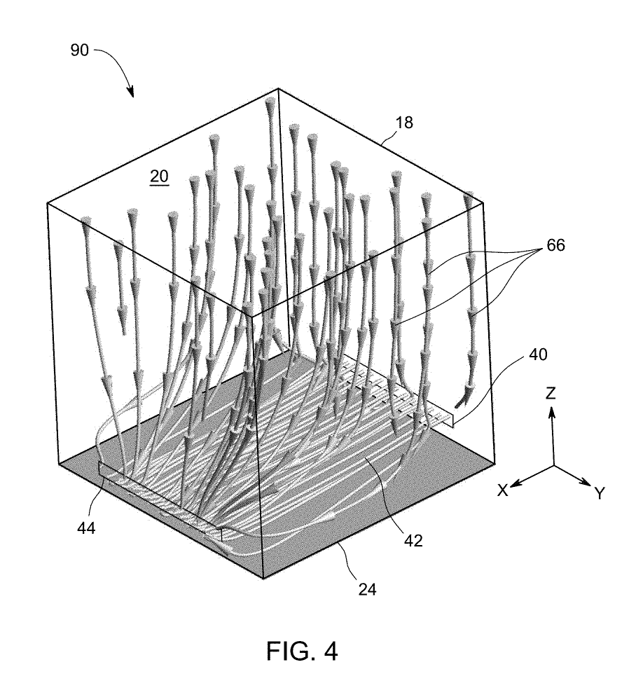

As set forth above, the presence of the second gas flow 66 may help substantially reduce or eliminate gas entrainment and chaotic gas flow, and thus improve the performance and efficiency of the AM system 10 by removing smoke and/or other particulates generated during the AM process. Simulated flow characteristics in the chamber 20 of the AM system 10 with and without the presence of the second gas flow 66 are discussed in FIGS. 3 and 4. FIG. 3 is a schematic three-dimensional view of results of an example simulation of flow characteristics in the chamber 20 of the AM system 10 including only the first gas flow 42, and not the second gas flow 66. In the illustrated embodiment, the simulated flow characteristics include a flow distribution 80 presented based on flow velocity (e.g., meters per second or m/s) according to a grayscale with relatively darker colors indicating relatively higher flow rate and relatively lighter colors indicating relatively lower flow rate. According to the simulation results, while the flow distribution 80 near the base portion 24 of the housing 18 (e.g., above the build platform 22) is substantially laminar, there is substantial gas entrainment and chaotic gas flow 82 extending a significant portion of the chamber 20. For the reasons set forth above, the gas entrainment and chaotic gas flow 82 are presently recognized as being undesirable and may lead to poor quality of the resulting object.

FIG. 4 is a schematic three-dimensional view of an example simulation result of flow characteristics in the chamber 20 of the AM system 10 including both the first gas flow 42 and the second gas flow 66 (e.g., chamber 20 of FIG. 2), in accordance with present embodiments. In the illustrated embodiment, the flow rate of the second gas flow 66 is about twice the flow rate of the first gas flow 42, and the simulated flow characteristics include a flow distribution 90 presented based on its flow velocity (e.g., m/s) according to a grayscale with relatively darker colors indicating relatively higher flow rate and relatively lighter colors indicating relatively lower flow rate. According to the simulation results, the second gas flow 66 enters the chamber 20 via the second gas inlet 64 from the top portion or top-wall 32 of the housing and remains substantially uniformly until it meets the first gas flow 42 and exits the chamber 20 via the gas outlet 44. According to the simulation results, the flow distribution 90 is substantially vertical (e.g., in the z-direction) throughout a significant portion of the height 70 of the chamber 20 and is substantially laminar near the base portion 24 of the housing 18 (e.g., above the build platform 22). Furthermore, there is no gas entrainment or chaotic gas flow in the chamber 20 (e.g., substantially zero gas entrainment or chaotic gas flow). As such, the simulation results shown in FIGS. 3 and 4 illustrate the combination of the second gas flow 66 and the first gas flow 42 may effectively suppress entrainment and recirculation of the smoke and/or particulate matter inside the chamber 20, and may contribute to improved quality of the resulting object.

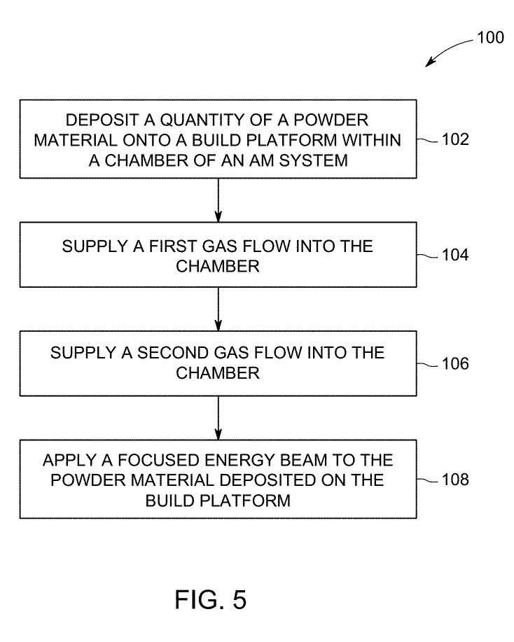

FIG. 5 is a flow chart of an embodiment of a method 100 for operating the AM system 10. One or more of the steps of the method 100 may be executed by the controller 12. Referring to the AM system 10 of FIGS. 1 and 2, the method 100 may include depositing (step 102) a quantity of a powder material onto the build platform 22 within the chamber 20 of the AM system 10. For example, the controller 12 may instruct the powder application device 26 to deposit the power material onto the build platform 22. The controller 12 may instruct the positioning system 36 to move the powder application device 26 and/or the platform 22 to any suitable positions relative to one another, in any of the x-, y-, and z-direction, or a combination of, to deposit the powder material in a layer-by-layer manner.

The method 100 may include supplying (step 104) the first gas flow 42 into the chamber 20. For example, the controller 12 may instruct the associated gas dispersal mechanism and/or other gas flow control mechanisms to supply the first gas flow 42 into the chamber 20. The controller 12 may instruct the associated gas dispersal mechanism to control the flow characteristics of the first gas flow 42, such as flow distribution, flow rate (e.g., mass flow rate, volume flow rate), flow direction, or any combination thereof. The controller 12 may instruct the associated gas dispersal mechanism to control content (e.g., argon, nitrogen, any other suitable inert gas, or a combination thereof) of the first gas flow 42. In some embodiments, the controller 12 may instruct the associated gas dispersal mechanism to supply the first gas flow 42 into the chamber 20 simultaneous to step 102.

The method 100 may include supplying (step 106) the second gas flow 66 into the chamber 20. For example, the controller 12 may instruct the associated gas dispersal mechanism and/or other gas flow control mechanisms to supply the second gas flow 66 into the chamber 20. The controller 12 may instruct the associated gas dispersal mechanism to control the flow characteristics of the second gas flow 66, such as flow distribution, flow rate (e.g., mass flow rate, volume flow rate), flow direction, or any combination thereof. The controller 12 may instruct the associated gas dispersal mechanism to control content (e.g., argon, nitrogen, any other suitable inert gas, or a combination thereof) of the second gas flow 66. The controller 12 may instruct the associated gas dispersal mechanisms and/or other gas flow control mechanisms to control the flow rates of the first gas flow 42 and the second gas flow 66, such that a ratio between the two gas flow rates is controlled at a desirable value or range (e.g., the flow rate of the second gas flow 66 may be in a range between about 1.5 times and about 2.5 times the flow rate of the first gas flow 42, between about 1.8 times and about 2.2 times the flow rate of the first gas flow 42, in a range between about 1.9 times and about 2.1 times the flow rate of the first gas flow 42, about 2 times the flow rate of the first gas flow 42). As set forth above, applying the second gas flow 66 in the chamber (step 106), in combination with the first gas flow 42 (step 104) may substantially reduce or eliminate gas entrainment and chaotic flow inside the chamber 20, thus eliminate or substantially reduce the measure and deposition of the smoke and/or particulate matter at various locations inside the chamber 20, which may lead to improved quality of the resulting object manufactured by the AM system 10.

The method 100 may include applying (step 108) a focused energy beam to the quantity of a powder material deposited on the build platform 22. For example, the control 12 may instruct the energy generating system 30 to apply the focused energy beam 31, such as a laser beam, to the powder bed 28. The focused energy beam 31 selectively melts and/or sinters the powder material of the powder bed 28 in a predefined manner to form a solidified layer.

In some embodiments, the steps 104 and 106 may be performed simultaneously. In some embodiments, the step 104 may be performed before or after the step 106. In some embodiments, the step 108 may be performed simultaneously to the step 104, the step 106, or both. In some embodiments, the step 108 may be performed before the step 104 or before the step 106. In some embodiments, the method 100 may repeat the steps 102, 104, 106, and 108 to form additional solidified layer on the previously formed solidified layer. In some embodiments, the method 100 may include performing the steps 104 and 106 every time after performing the step 108. In some embodiments, the method 100 may include repeating the steps 102, 104, 106, and 108 multiple times to form successive additional solidified layers to form the desired article (e.g., the step 108 is performed while the steps 104 and 106 are performed continuously).

The technical effects of the present disclosure include improving the performance and efficiency of an AM system by removing from the chamber, smoke and/or other particulates generated during the AM process. The disclosed AM system employs a combination of laminar gas flow (e.g., a first gas flow) supplied parallel to a build platform from the side of the chamber and a vertical gas flow (e.g., a second gas flow) supplied perpendicular to the build platform from the top of the chamber. The combination of the laminar and vertical gas flows can substantially reduce or eliminate entrainment and recirculation of the smoke and/or the particulate matter inside the chamber.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An additive manufacturing system, comprising:
a housing defining a chamber;
a build platform disposed in a lower portion of the chamber;
a first gas inlet, disposed in a first side-wall of the chamber, configured to supply a first gas flow parallel to the build platform;
a second gas inlet configured to supply a second gas flow in a direction substantially perpendicular to the build platform; and
a gas outlet configured to discharge the first and second gas flows from the chamber.

2. The additive manufacturing system of claim 1, wherein the second gas inlet is disposed at a top-wall of the chamber.

3. The additive manufacturing system of claim 2, wherein the second gas inlet comprises a plurality of substantially circular openings in the top-wall of the chamber.

4. The additive manufacturing system of claim 1, wherein the second gas inlet is disposed at a greater vertical height than the first gas inlet within the chamber.

5. The additive manufacturing system of claim 1, wherein the gas outlet is disposed in a second side-wall of the chamber, opposing the first side-wall.

6. The additive manufacturing system of claim 1, wherein the first gas inlet is disposed at a greater vertical height than the build platform.

7. The additive manufacturing system of claim 1, wherein the second gas flow and the first gas flow are supplied at a gas flow rate ratio that is 2:1.

8. A method of operating an additive manufacturing system, comprising:
depositing a quantity of a power material on a build platform within a chamber;
supplying a first gas flow into the chamber horizontally above the build platform;
supplying a second gas flow into the chamber in a direction substantially perpendicular to the first gas flow; and
applying a focused energy beam to at least a portion of the quantity of the powder material deposited on the build platform to form a solidified layer.

9. The method of claim 8, wherein supplying the second gas flow comprises supplying the second gas flow at a second flow rate that is about two times a first flow rate of the first gas flow.

10. The method of claim 8, wherein supplying the second gas flow comprises supplying the second gas flow in a substantially uniform manner in the chamber.

11. The method of claim 8, wherein supplying the second gas flow comprises supplying the second gas flow simultaneously to supplying the first gas flow.

12. The method of claim 8, wherein supplying the first gas flow comprises supplying the first gas flow simultaneously to applying the focused energy beam.

13. The method of claim 8, comprising repeating applying the focused energy beam for forming at least one additional solidified layer on the previously formed solidified layer while continuously supplying the first gas flow and the second gas flow.

14. An additive manufacturing system, comprising:
a housing defining a chamber;
a build platform disposed in the chamber;
a powder application device arranged in the chamber and configured to dispose a bed of powder material onto the build platform;
an energy generating system configured to generate and direct a focused energy beam onto at least a portion of the bed of powder material;
a positioning system coupled to the build platform, the energy generating system, the powder application device, or a combination thereof, and configured to move the build platform, the energy generating system, the powder application device, or a combination thereof, relative to one another;
a first gas inlet configured to supply a first gas flow horizontally above the build platform;
a second gas inlet configured to supply a second gas flow in a direction substantially perpendicular to the first gas flow; and
a gas outlet configured to discharge the first and second gas flows.

15. The additive manufacturing system of claim 14, wherein the second gas inlet is arranged at a top-wall of the chamber.

16. The additive manufacturing system of claim 15, wherein the second gas inlet comprises a plurality of openings in the top-wall of the chamber, and the first gas inlet comprises one opening.

17. The additive manufacturing system of claim 14, comprising a controller configured to control a first flow rate of the first gas flow and a second flow rate of the second gas flow, such that the second flow rate is about 1.5 times to about 2.5 times the first flow rate.

18. The additive manufacturing system of claim 17, wherein the second flow rate is about two times the first flow rate.

19. The additive manufacturing system of claim 14, wherein the first gas inlet is disposed in a first side-wall of the chamber and the gas outlet is disposed in a second side-wall of the housing, opposing the first side-wall.

20. The additive manufacturing system of claim 14, wherein the first gas flow and the second gas flow comprise inert gas.
